(19) United States
(12) Patent Application Publication
(10) Pub. No.: US 2003/0208596 A1
(43) Pub. Date: Nov. 6, 2003

(54) System and method for delivering services over a network in a secure environment

(76) Inventors: Jason T. Carolan, Superior, CO (US); Mikael Lofstrand, Surrey (GB)

Correspondence Address: HOGAN & HARTSON LLP, ONE TABOR CENTER, SUITE 1500, 1200 SEVENTEEN ST., DENVER, CO, 80202, US

(21) Appl. No.: 10/136,412

(22) Filed: May 1, 2002

(51) Int. Cl. G06F 15/173

(52) U.S. Cl. 709/225

(57) ABSTRACT

A system and method for delivering services in a secure manner is disclosed. The system includes a network that delivers services to end users. The network includes a service module that supports a service. The service module can deliver more than one service. The network also includes a load balancing switch to provide a virtual internet protocol address for the service. A data packet enclosing a request for the service is routed by the load balancing switch. The network also includes a distribution module coupled to the service module and routes the data packet to the load balancing switch. The network also includes a security module to determine if the data packet is authorized for the virtual internet protocol address. If so, then the service is provided to the end user. If not, security measures are taken to deny the end user access to the services.

### CROSS-REFERENCE TO RELATED APPLICATIONS

This application claims the benefit of U.S. application Ser. No. 10/103,494, filed Mar. 20, 2002, entitled SERVICE DELIVERY NETWORK SYSTEM AND METHOD which is incorporated by reference herein in its entirety.

### BACKGROUND OF THE INVENTION

1. Field of the Invention

The present invention relates to information networks, and, more particularly, the present invention relates to information exchange networks that electronically deliver information, data, and service to end-users.

2. Discussion of the Related Art

Today's networks move information and services. As advances are made in existing and future technologies, the demand for information will increase. Network design and solutions may have to account for a large number of users, transactions, and diverse content types. The designs and solutions may result in a different approach than that of standard infrastructures. Networks should support convergent services with high reliability and performance, while maintaining manageability and security. Typical networks may be designed based on a client-server architecture. Client-server architecture can lead to network design being completed before the services architecture is complete, and may decrease flexibility for services within the network to support multi-tiered services.

Many technology companies concentrate on services to the end user, rather than the technology itself. Service-based architectures may be applications that are accessed over internet protocol (“IP”) networks, such as domain name systems (“DNS”), Web, file transfer protocol (“FTP”), telnet, and the like. Web servers provide the front-end access points to the desired applications. For future architectures, the applications may need to be redesigned to map into a new architectural shift. Upgrading software and hardware without downtime may be difficult and may result in a re-design of the system architecture to introduce new services. Challenges may include satisfying growth and a need for continuous availability.

Several factors may impact future computing platforms and services delivered by service providers, such as bandwidth availability and growth, wireless services, disaster recovery and services, computer processing growth, and the like.

### SUMMARY OF THE INVENTION

Accordingly, the disclosed embodiments are directed to a delivering services over a network in a secure manner.

According to the disclosed embodiments, a network for delivering a plurality of services in a secured manner is disclosed. The network includes a service module supporting a service from the plurality of services. The network also includes a load balancing switch to provide a virtual internet protocol address for the service. A data packet is routed to the service using the virtual internet protocol address. The network also may include a distribution module coupled to the service module. The distribution module routes the data packet to the load balancing switch. The network also includes an integration security module coupled to the distribution module. The integration security module passes the data packet to the distribution module when the data packet is authorized for the virtual internet protocol address.

According to the disclosed embodiments, a network configured to deliver a service in a secured environment also is disclosed. The network includes a service module hosting the service. The service correlates to a virtual internet protocol address. The network also includes a load balancing switch to route information to the service according to the virtual internet protocol address. The network also includes a service security module to determine whether a data packet for the service is authorized according to the virtual internet protocol address.

According to the disclosed embodiments, a method for delivering a request for a service over a network in a secure manner also is disclosed. The method includes receiving the request for the service. The request comprises a data packet bound for a virtual internet protocol address. The method also includes determining with a security module whether the data packet is authorized for the virtual internet protocol address. The method also includes forwarding the request to a service domain correlating to the virtual internet protocol address when the data packet is authorized by the security module.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a network in accordance with an embodiment of the present invention.

FIG. 2 illustrates a network configuration within a service delivery network in accordance with an embodiment of the present invention.

FIG. 3 illustrates an integrated security model for a service delivery network in accordance with an embodiment of the present invention.

FIG. 4 illustrates an integration security module within a network in accordance with an embodiment of the present invention.

FIG. 5 illustrates a service security module within a network in accordance with an embodiment of the present invention.

FIG. 6 illustrates a firewall sandwich in accordance with an embodiment of the present invention.

FIG. 7 illustrates a flowchart for delivering a data packet in a network having a security configuration in accordance with an embodiment of the present invention.

### DETAILED DESCRIPTION OF THE DISCLOSED EMBODIMENTS

Reference will now be made in detail to the disclosed embodiments of the present invention, examples of which are illustrated in the accompanying drawings.

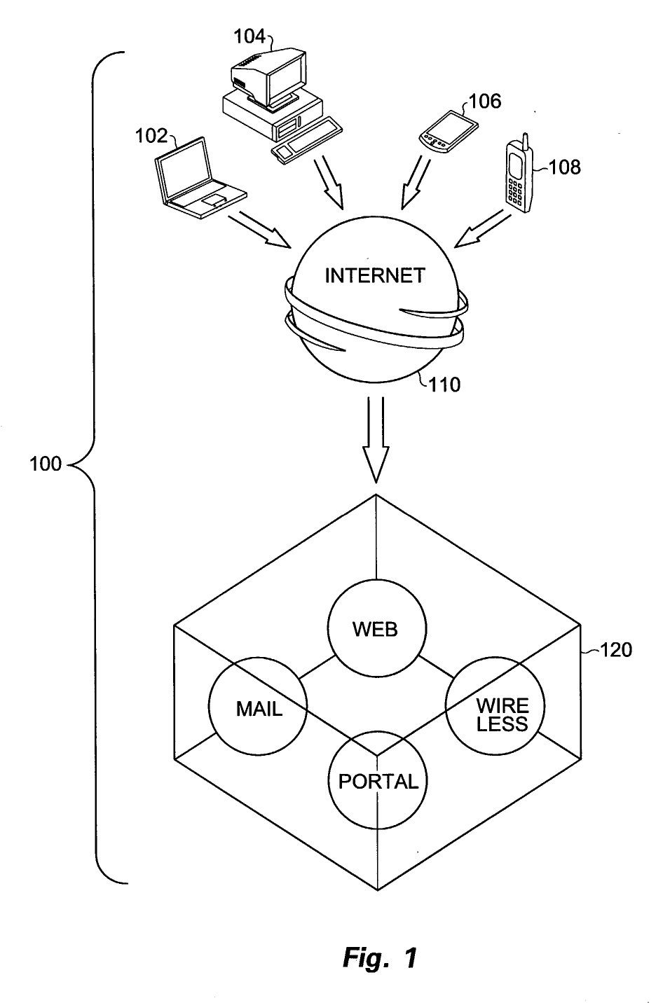

FIG. 1 depicts a network 100 in accordance with an embodiment of the present invention. Network 100 may be any network capable of transferring data and information from one component to another. Network 100 also may deliver requested services to end-users connected to network 100. For example, network 100 may include laptop 102, desktop 104, personal digital assistant (“PDA”) 106, and wireless telephone 108 that are linked to internet 110. These components may send and receive information from each other, or from other sources. Each component may receive information and data over internet 110 in a known manner.

Internet 110 may be coupled to data centers. Specifically, internet 110 may be coupled to service delivery network (“SDN”) 120. Internet 110 also may be coupled to other SDNs and data centers. Internet 110 may be coupled to a plurality of SDNs 120. SDN 120 is a data services platform for scalable data centers. The services provided over network 100, and supported by SDN 120, may include end-user, supporting, and infrastructure. Services are products or resources offered over a network to meet or to provide specific business requirements and may be categorized in different ways.

End-user services may be provided directly to an end-user, and may include a Web site, email capability, Usenet services, and the like. Supporting services may support end-user services. Supporting services may include an application server providing dynamic content for a Web site or e-commerce application. The end-user service, however, is the service access point, and users should not directly initiate connections into a supporting service. Infrastructure services may ease internal operations and support, and may include system and network management services. An example of an infrastructure service may be an internal DNS service. Infrastructure services should not interact directly with end-user services.

SDN 120 may focus on the services delivered to the end-user, as opposed to technology, servers, or other components of network 100. Thus, SDN 120 may be known as a service-driven network. Alternatively, SDN 120 may focus on these issues in addition to delivered services. SDN 120 may be known as a client-service architecture in that the client connects to a service and not directly to a server. A user, for example, may not be interested in connecting to a specific server, but, instead, desires to connect to a requested service. SDN 120 can focus on the service for a highly scalable, module-based network topology that may grow as services grow, while keeping security and flexibility intact. Referring to FIG. 1, SDN 120 may provide mail, Web, portal, and wireless services to the components coupled to internet 110. These services may be supported by their own architectures.

SDN 120 may support unified service data centers. As services and providers continue to converge and provide different types of services, SDN 120 may provide increased speed, increased bandwidth-capable solutions with increased availability and flexibility. SDN 120 also promotes a client-service architecture that focuses on the services delivered to the customer, as opposed to servers. The customer, for example, may use laptop 102, desktop 104, PDA 106, or telephone 108, as disclosed above to access the services supported by SDN 120. SDN 120 may take advantage of a true service-driven architecture by virtualizing the servers and understanding the core services offered to the end user and data center services.

Within SDN 120, integration points may be standardized in a secure and manageable manner. This feature may increase system and network management integration, and enables SDN 120 to maintain a consistent qualifying of service expectations for the service delivery. In addition, future data centers may demand architectures that keep the same structure, even if the hardware, software, or traffic pattern changes. An increase or decrease of services, servers, and applications may be supported. SDN 120 may support this flexibility with minimal or no service interruption.

SDN 120 also may feature integrated security. Security capabilities may be provided throughout the architecture, thereby protecting the servers, network hardware, and the data. Security may be provided at increased, or high, speeds and with low latency, while protecting the customer's valuable networked resources. Security features of the disclosed embodiments are disclosed in greater detail below.

SDN 120 may be comprised of modules. Some of the modules may be needed, and others may be optional. Using modular design, SDN 120, and network 100, may be extended and expanded to meet changing service requirements. For example, SDN 120 may provide the foundation of network 100 for a multi-customer IDC that allows each customer to determine specific security or performance requirements.

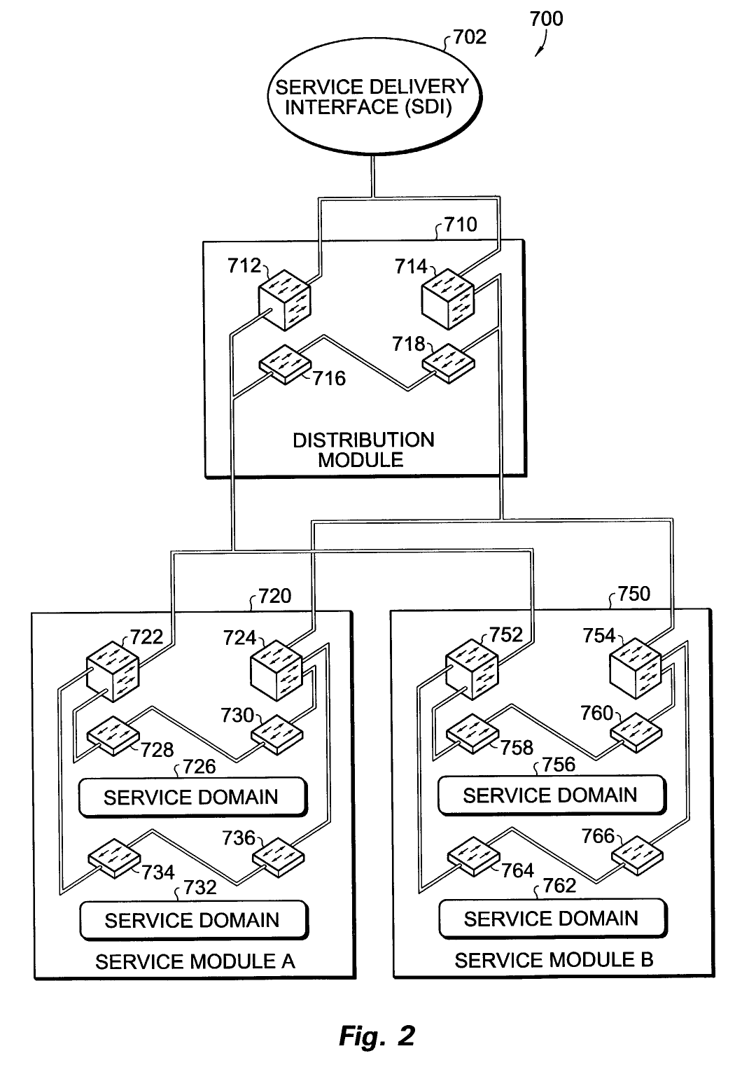

FIG. 2 depicts an example network configuration within a network 700 in accordance with an embodiment of the present invention. Network 700 is for illustrative purposes only, and the disclosed embodiments are not limited to the configuration of network 700. Network 700 includes interface 702. The link should have the capacity to support the requirements of the network and services. Network 700 also includes distribution module 710 and service modules 720 and 750. Distribution module 710 includes active load balancing switches (“LBSs”) 712 and passive LBS 714, as well as host connection switches (“HCSs”) 716 and 718.

Service module 720 includes active LBS 722 and passive LBS 724. Service module 720 also includes service domains 726 and 732, that are coupled within service module 720 by HCSs 728 and 730, and HCSs 734 and 736, respectively. Service module 750 includes active LBS 752 and passive LBS 754. Service module 750 also includes service domains 756 and 762, that are coupled within service module 750 by HCSs 758 and 760, and HCSs 764 and 766, respectively.

Routing within network 700 may be performed by LBSs 712, 722 and 752. Routing is desired when a host, or server, attempts to communicate to another host or client off of its network segment, such as a service domain. After the router within an LBS identifies the location of a particular destination network or host, then the LBS may forward the packet appropriately. Network 700 provides routing in service modules 720 and 750 by using the same hardware that performs the load balancing. Because each service is divided into service domains, the division provides for a highly scalable and high performing approach to service routing. The division of services also allows for additional controls to ensure certain types of packets are routed through network 700 into each service domain.

Inter-service domain routing may be accomplished by the following example. Hosts in service domains, such as service domain 726, may communicate to other hosts in service module 720, such as a supporting service. Two processes may provide inter-service domain communications. First, a service virtual internet protocol (“VIP”) address may be provided through the LBSs. This approach enables the supporting service to be load balanced as well, such a set of DNS servers or LDAP servers. A set of service VIPs may be maintained like any other service in the LBSs, such LBSs 722 and 724. Alternatively, a static route may be provided to the particular host IP or set of IP addresses that is automatically maintained by the LBS, such as LBS 722. If load balancing is not desired, direct communication may be supported through static, or direct, routes to each network in the LBS.

Routing outside the service module, such as service module 720, may be accomplished as follows. Routing to systems or networks outside the service module also may be provided by the LBSs, such LBS 722. LBS 722, for example, may be configured with static routes or may use routing protocols such as RIP, OSPF, or BGP. This route may include access to SDI 702 and the primary integration network, such as the internet. Many environments without BGP may use static route configurations because most internal addresses are private. This aspect allows for simple configuration of outside networks and a simple static configuration.

LBSs 722 and 752 may provide several functions related to load balancing, such as translation, redirection, and health checks. Regarding translation, each LBS, such as LBS 722, publishes a service VIP for various services. The service VIP may be publicly available and is routed over the network coupled to network 700. Two variations of service VIPs may exist. First, a public VIP may exist that is based on an internet routable IP address. Second, a private VIP may exist that is based on the RFC 1918 private IP address ranges. When a client connects to the service VIP, LBS 722 makes a decision based on the redirection and health check settings, and rewrites the packet, replacing the destination address and forwarding the packet to the desired host within its supporting service domain, such service domain 726. After the response has been made by the host, the packet is directed back to LBS 722 and the packet is rewritten again by replacing the address with the service VIP. The client should not be aware of this activity.

Redirection, or load balancing, indicates the ability for LBS 722, or other LBSs, to make various decisions based on settings and dynamic information obtained from health checks. Each LBS within network 700, such as LBS 722, is configured with a service VIP and with a load distribution algorithm, such as least connections or hashing. Unless session persistence or source-destination hashing is used, the client may receive a response from any host running the service. This feature may be desirable because the LBS may redirect the client to the server with the least connections. If the client is redirected to the same host every time, such as an application server holding session information, persistence should be used.

Scalability of services infrastructure maintains adequate service levels with a constantly growing and expanding customer base. The ability to add new services or to enhance existing services should be supported by the network architecture and not require significant changes. The scaling model for adding services according to the disclosed embodiments should be similar to server scaling. Server scaling may be discussed in terms of horizontal and vertical scaling. Adding servers offering the same service may be an example of horizontal scaling. Vertical scaling may involve adding CPUs or other hardware components within the same server. Some applications may not take advantage of additional server hardware and should be horizontally scaled. In some instances, the vertically scaled server may be out of capacity and is scaled by adding more hosts. This technique may be applied to SDN 700.

Services may be added within service domains 726, 732, 756, or 762. Additional service domains may be added to service modules 720 or 750 by adding HCSs. If additional capacity is desired by a service, the service may be split into different service domains, although the service delivery integration is shared by the entire service module. Adding service domains may be limited by specific hardware density and limitations.

If additional service domains are desired within, for example, service module 720, a service module may be added and integrated using distribution module 710. With two service modules, such service modules 720 and 750, the bandwidth support by interface 702 may increase, even though each service module is still serviced through the bandwidth of the original connection. To use the increase bandwidth capacity of interface 702, services should be distributed between service modules 720 and 750.

Distribution module 710 enables multiple service modules 720 and 750 to be connected and integrated to form network 700. Distribution module 710 may be desirable for additional services or service domain are needed because the number of services in a service module has reached its maximum capacity. Distribution module 710 also is desired for additional bandwidth for interface 702. Further, distribution module 710 may be desirable when content delivery network requirements use large capacity caches that should be integrated as close to interface 702 as possible. Additional availability may be needed and addressed by distributing service modules to another location. Distribution module 710 may act as a distribution layer to transfer data and services to a separate site by using long-wave optical connections. Thus, distribution module 710 introduces an amount of flexibility by allowing customer needs, requirements, and services to change while still using the same basic service modules.

Distribution module 710 may be comprised of two LBSs 712 and 714 that provide load balancing and routing, and two HCSs 716 and 718 that provide scalable connections and allow for limited host connections, such as large high-speed content cache servers. By using HCSs 716 and 718, the ports on LBSs 712 and 714 may be used for connections to interface 702, as opposed to limiting the number of service modules that may be supported. The HCSs within distribution module 710 may be expanded to include more service modules.

Distribution module 710 provides various capabilities for network 700. Some of these functions may be moved from the distribution layer and integration layer in a service module to the distribution module. Distribution module 710 provides high performance, wire-speed bridging and routing with low latency. Distribution module 710 also provides a scalable design with service module connection options. Distribution module 710 also provides network address translation capabilities without additional hardware. Distribution module 710 also provides a highly available infrastructure without a single point of failure and several methods to ensure service module network availability. Distribution module 710 also provides bandwidth management with guaranteed throughput to various services and/or clients with various quality of service capabilities. Distribution module 710 also provides content-based load balancing with delayed session binding support, a variety of health checks, and various load balancing algorithms and persistence options. Distribution module 710 also provides single service virtual IPs that are available to customers and distributed intelligently based on load and geographical data. Distribution module 710 also provides a managed network giving support for common network management platforms, with secure administration.

Distribution module 710 also provides connectivity and routing access to service modules 720 and 750 and to interface 702, or integration network. Routing within a service module may still be handled by the LBSs within the local service module. Interface 702, however, provides access to the primary integration network, such as the internet. The integration network may be responsible for routing to and from interface 702 and LBSs 712 and 714. After a packet reaches LBSs 712 and 714, LBSs 712 and 714 are responsible for routing the packet in network 700. This routing may be accomplished by static route table entries in LBS 712 or 714. Traffic from service modules 720 and 750 with a destination inclusive of the integration network, or its connections, also may be routed by using static routes.

Data routing between service modules 720 and 750 also may be provided by distribution module 710. The routing may be configured using static route entries because they do not require dynamic updates and are constantly available. Additional routes should not be needed to support additional hosts but may be desired to support additional service domains.

The load balancing functions at distribution module 710 should be identical to those within service modules 720 and 750. Because of the hierarchical arrangement, some functions may be distributed to the distribution module layer that offloads some of the traffic at each service module. The arrangement also allows for additional content load balancing to occur above service module 720 and 750 and redirection to edge services, such as cache servers. The cache servers may cache content located anywhere within any service module or even the integrated network. The arrangement may serve to limit the amount of traffic routing through each service module.

Distribution module 710 also may provide a monitoring function for service modules 720 and 750. A very high availability environment may include the same service being in separate service modules. Distribution module 710 may perform health checks on each service. This feature may allow a site to take down one service domain having the service for maintenance, and keep the other service domain running.

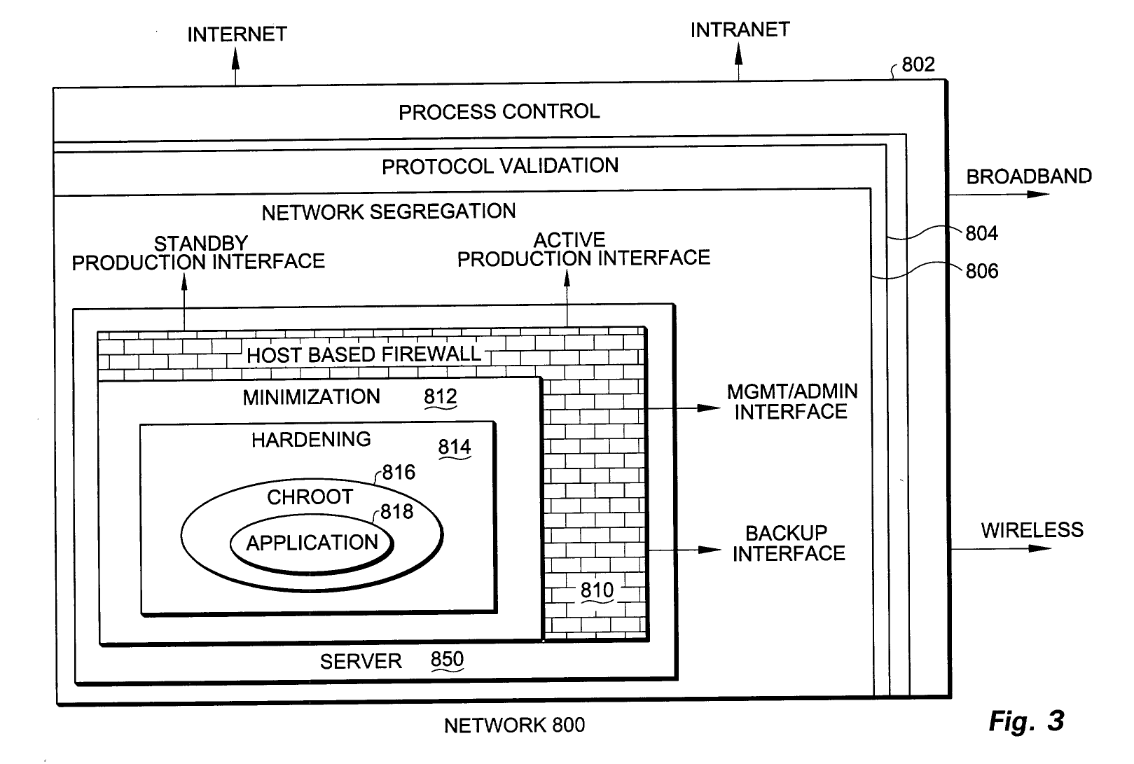

FIG. 3 depicts an integrated security model 800 for a network in accordance with an embodiment of the present invention. Security in a network may depend on securing each aspect of the path that is taken by traffic as it flows through networks, components, and applications, and seeking to minimize performance and latency. Integrated security model 800 considers the security features in all applications, servers, networks, security modules, and other security features in all the different interfaces in the service delivery. Segments of any proposed network architecture should be examined to maintain a low impact on performance and to maintain low latency and high bandwidth. Further, the volume of complex security checks should be minimized without degrading the overall security. A decentralized approach to security in a service delivery network may allow the components to protect themselves. The decentralized approach enables the ability to provide a high level of security with few, if any, inspection bottlenecks.

Integrated security model 800 correlates to a network by communicating to different networks, as depicted in FIG. 8. For example, services protected by integrated security model 800 may be delivered over internet, intranet, broadband, or wireless networks. The first layer of integrated security model 700 may be known as a process control 802. Process control 802 may include lightweight port filtering and access control lists on a load balancing switch within a service delivery network. Process control 802 may be used to restrict access for services that require such restriction. Filters may be used to deny access by default on every port and to tie an alert mechanism to the port. Filters may be able to forward-drop or redirect the traffic.

The filters and access control lists of process control 802 may be used to allow traffic to certain services as desired. Filters and access control lists may limit traffic to and from a an interface, as disclosed above, or specific services domains, if necessary. Hosts and network appliances within services may not initiate outbound traffic without an LBS being configured specifically to allow the traffic. This feature enhances security because rogue applications may not initiate connections to the outside world, or networks.

Process control 802 may use the following items in controlling access: IP source, IP address and netmask; IP destination, IP address and netmask; protocol type (IP, UDP, TCP, ICMP); TCP flags; application source port, by name, integer or range; application destination port by name, integer or range; and the like. Filters for process control 802 may deny all as the last filter on each port or deny the private IP address ranges on ingress ports from the internet.

The next layer may be known as protocol validation 804. Protocol validation 804 may use server load balancing to give scalability, availability, reliability and increased efficiency for the services. The manner that server load balancing is processed may allow a LBS to publish the public IP address as a front-end to the real servers that reside on a private IP address range and is not routable to the internet or other outside networks.

Protocol validation 804 may execute server load balancing as follows. For example, the client connects to the virtual Web server with source address and destination address on public IP networks. The virtual Web server connects to the real Web servers with the source address of the client and the destination address of one of the real Web servers on a private network. The reply from the real Web server to the virtual Web server uses the source address of the real Web server on a private network and the destination address of the client. The reply to the client uses the source address of the virtual Web server and the destination address of the client.

The TCP/UDP part and protocol validation 804 also may use filters and access control lists, as disclosed above to limit access to services within a service delivery network. These filters and access controls lists may operate independently from the filters and access control comprising process control 802. Alternatively, the filters and access control lists may work in conjunction with the filters and access control lists of process control 802.

The next layer of integrated security model 800 may be known as network segregation 806. Network segregation 806 may use network segments in providing security for a service delivery network. For network segments, three banks of private IP addresses may be used to provide network addresses for the internal hosts. Every service should be kept in separate IP networks for the ease of securing each service. Tagged virtual local area networks should be avoided because a tag may be manipulated as it passes between switches. Untagged virtual local area networks may be considered as a possible implementation feature, but the robustness of the switch should be determined.

In a network architecture, separate physical switches may be implemented for each service. The switches are easier to maintain and replace when a failure occurs because the switches require little, if any, configuration. The switches also offer a mix of media and capacity, and allow for excellent flexibility. If a chassis-based solution is used, the chassis should allow private virtual local area network support and separation of services based on blades or cards. Virtual local area networks supported by network architectures should be port-based.

Thus, using network segregation 806, the virtual Web server for a service may be on a public IP network. The real servers may be on a private IP network. The virtual application server may be on a private IP network. The real application servers may be on a private IP network.

Integrated security model 800 may include server 850 that uses host-based security integration. Server 850 also may be known as a host or network appliance. According to the disclosed embodiments, server 850 should be secure at every layer of the network architecture. Preferably, every host, server, and network appliance in the services should be secure at every layer. Each service may have different security requirements. The vulnerability and exposure of each service may affect the security requirements, as well as the manner in which the service connects to hosts and layers in other services. Each host, server, and network appliance should be customized for its purpose, but modeled after integrated security model 800. For example, because of the security implications involved, a Web server may not provide any other service, such as a database.

Server 850 also may have various interfaces to the other layers within integrated security model 800. For example, server 850 may have a standby production interface, an active production interface, a management/administration interface, and a backup interface.

Host-based firewall 810 may be a layer within the host-based security integration. Host-based firewalls, such as host-based firewall 810, should be on every host. The firewalls protect the host, such as server 850, and an application 818. Firewall rule-sets should depend on customer requirements. For example, a rule-set may state that a connection is allowed from the Web server in the service to the application, or virtual, service IP, but no other connection may be allowed. Thus, any host, server, or network appliance that is not on the same network as the Web server in the service may not be able to connect to the virtual server IP for application 818. No direct connections may be allowed to the real application servers. Instead, connections should be made through the virtual, or application, service IP. A real server connection to another real server should be stopped by host-based firewall 810.

Minimization 812 may be a layer within the host-based security integration of server 850. Minimization 812 improves security by removing security holes in the operating system. System attacks may take advantage of security holes. Minimization refers to the installation of the minimal operating system that is necessary to run server 850. Any software that does not relate directly to the operation of server 850 may not be installed or may be deleted after the installation.

Hardening 814 may be a layer within the host-based security integration of server 850. Hardening 814 may modify the default configuration of the operating system to remove security vulnerabilities inherent in server 850. Every host within a service delivery network should be hardened.

Chroot environment 816 may be a layer within the host-based security integration of server 850. Chroot environment 816 may increase the security of the software on server 850. Chroot environment 816 may keep a process from accessing most of the file system in the environment. The process may not create, read, or write to files outside the environment. For example, a Web server should not need to know the system password or the configuration of a connection on the management interface. Thus, chroot environment 816 keeps the resources in the environment on a need-to-know basis.

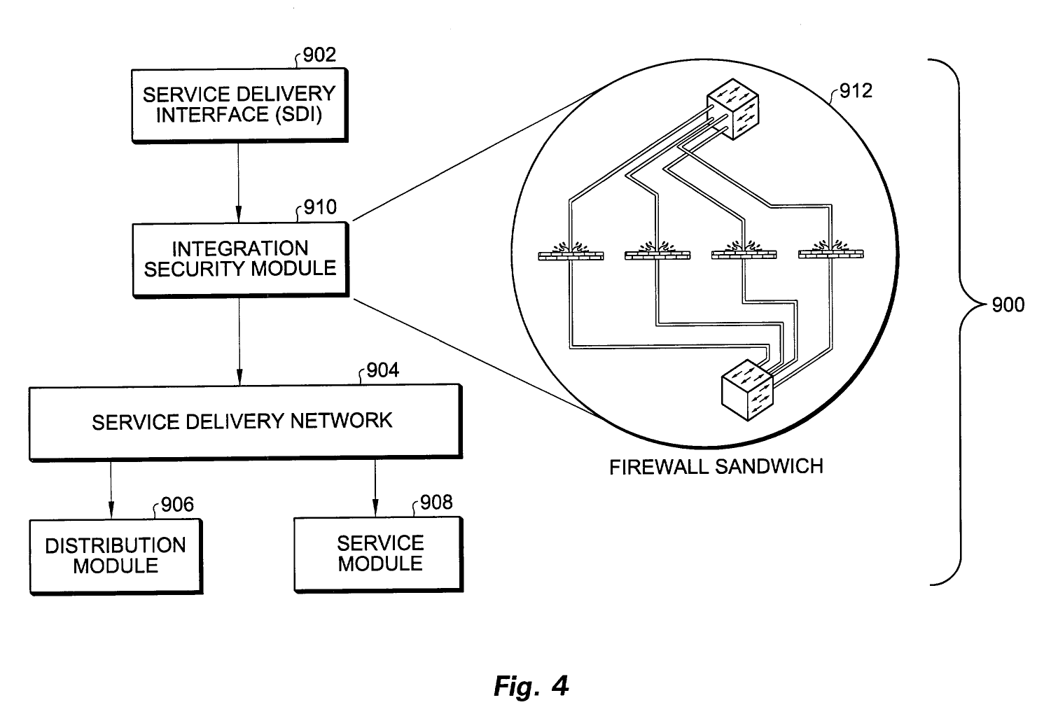

FIG. 4 depicts an integration security module 910 within a network 900 in accordance with an embodiment of the present invention. Security modules, such as integration security module 910, enhance the integrated security provided by the host platform, network 900, service delivery network (“SDN”) 904, hosted applications, and the like. Security modules, therefore, include a security enhanced configuration. Integrated security module 910 is coupled between SDN 904 and service delivery interface 902. Service delivery interface 902 may be known as the primary integration network. SDN 904 may comprise distribution module 906 and service module 908. SDN 904 also may include additional distribution modules and service modules. Integration security module 910 may protect the leading line of network hardware and switches, while providing logging and access control. Integration security module 910 also may provide VPN services according to the network implementation.

Integration security module 910 may be provided by a scalable, firewall complex 912. Firewall complex 912 may be configured as a firewall sandwich. For high-bandwidth networks, such as network 900, additional firewall applications may provide highly-available and scalable firewall services.

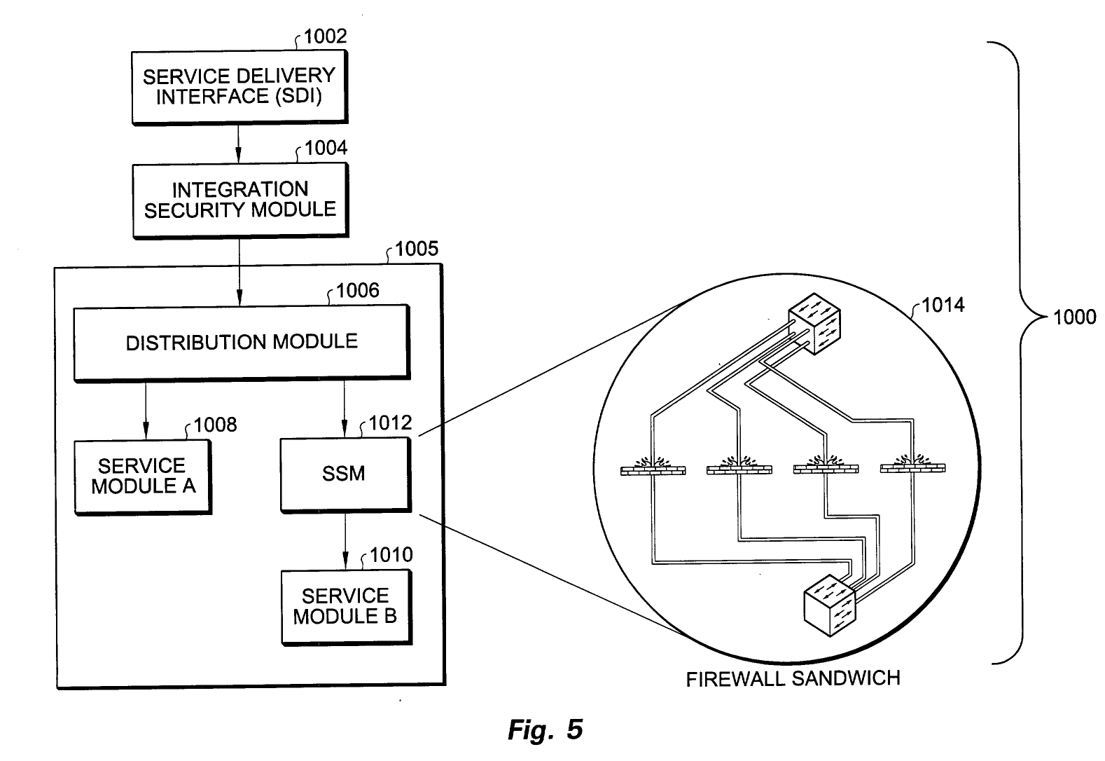

FIG. 5 depicts a service security module 1012 within a network 1000 in accordance with an embodiment of the present invention. Service security module 1012 may be used to secure a sensitive service module and/or to allow for several different firewall technologies to be used in network 1000. Thus, service security module 1012 has a security-enhanced configuration. Firewalls may have a downside within networks. Firewalls may introduce latency into network 1000, as processing each packet takes time. Applications, such as WAP, may even have a greater impact on latency. The applications may include a huge quantity of small packets that have a negative scaling effect on firewalls. Depending on the service requirements, the integrated security in a SDN may be sufficient. Billing data and other critical information, however, may desire extra protection behind a firewall complex.

Network 1000 includes service delivery interface 1002 that couples to SDN 1005 via integration security module 1004. Distribution module 1006 may be a component within SDN 1005. Distribution module 1006 interacts with service modules 1008 and 1010. Service module 1010 may be identified as a sensitive service module. For example, the security constraints on service module 1010 may be greater than those on service module 1008. The increased latency in receiving services from service module 1010 may be an acceptable tradeoff for the increased security. Service security module 1012 provides this security between service module 1010 and the other components of SDN 1005. In an embodiment, service security module 1012 may be comprised of firewall sandwich 1014.

The use of service security modules, such as service security module 1012, allows flexibility in the configuration of SDN 1005. Service security modules may be added and removed as the need arises from the individual services without sacrificing access throughout SDN 1005. Further, as service modules are added to SDN 1005, determinations can be made as to whether the increased security via service security modules is desired. Security itself is not sacrificed as the security measures and components disclosed above, such as integration security module 1004, may still be implemented.

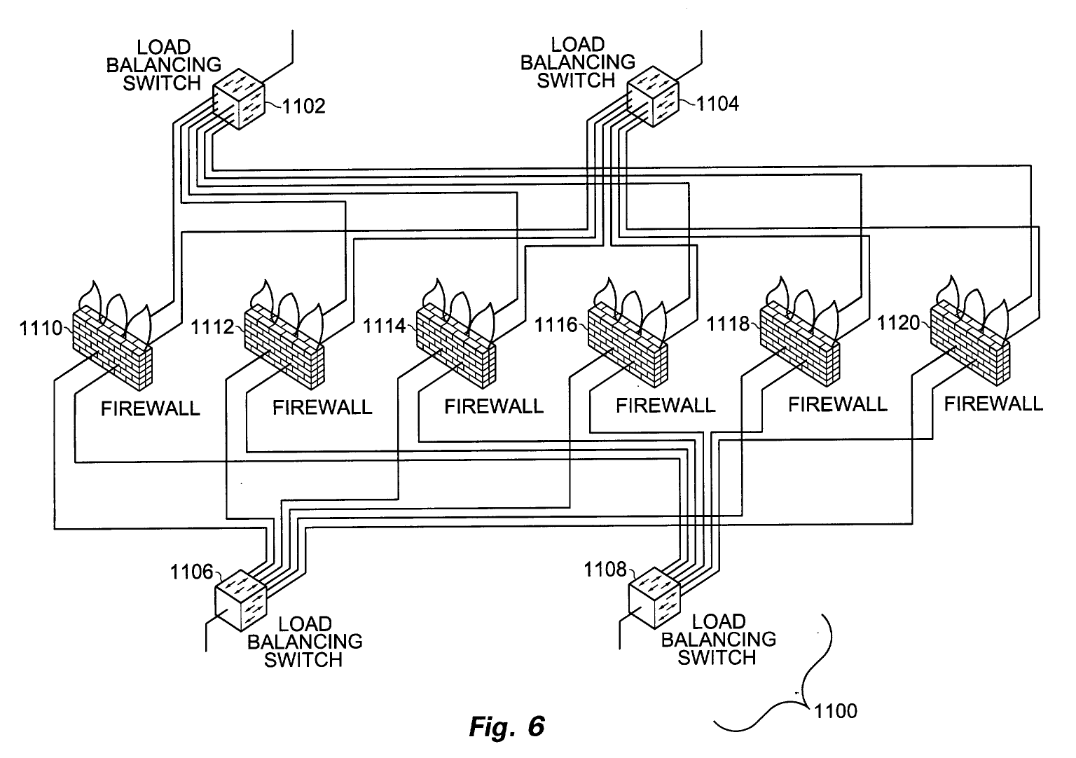

FIG. 6 depicts a firewall sandwich 1100 in accordance with an embodiment of the present invention. Firewalls may affect scalability, flexibility, and performance, but, however, should not be a hindrance between the service domains and other layers within the service delivery network architecture. Firewall sandwich 1100 includes LBSs 1102, 1104, 1106, and 1108. LBSs 1102-1108 are coupled to firewalls 1110, 1112, 1114, 1116, 1118, and 1120. Firewalls 1110-1120 examine every packet that traverses an attached network. This process may introduce latency and impact performance on the inspecting firewall. Firewall scalability may be affected by two factors. First, the number of sessions may affect scalability. Second, the amount of capacity or bandwidth may affect scalability.

The performance impact may be related to the number of packets to be examined. For example, FTP transfers may have larger packet sizes. The examinations may not impact firewall performance like a smaller transactional application, such as HTTP or WAP. Firewall sandwich 1100 provides an alternative to known firewall configurations. Firewall sandwich includes scalable firewall complexes that combine high-speed load-balancing switches 1102-1108 with standard software-based firewalls 1110-1120. Firewall sandwich 1100 may be implemented in any of the network configurations disclosed above.

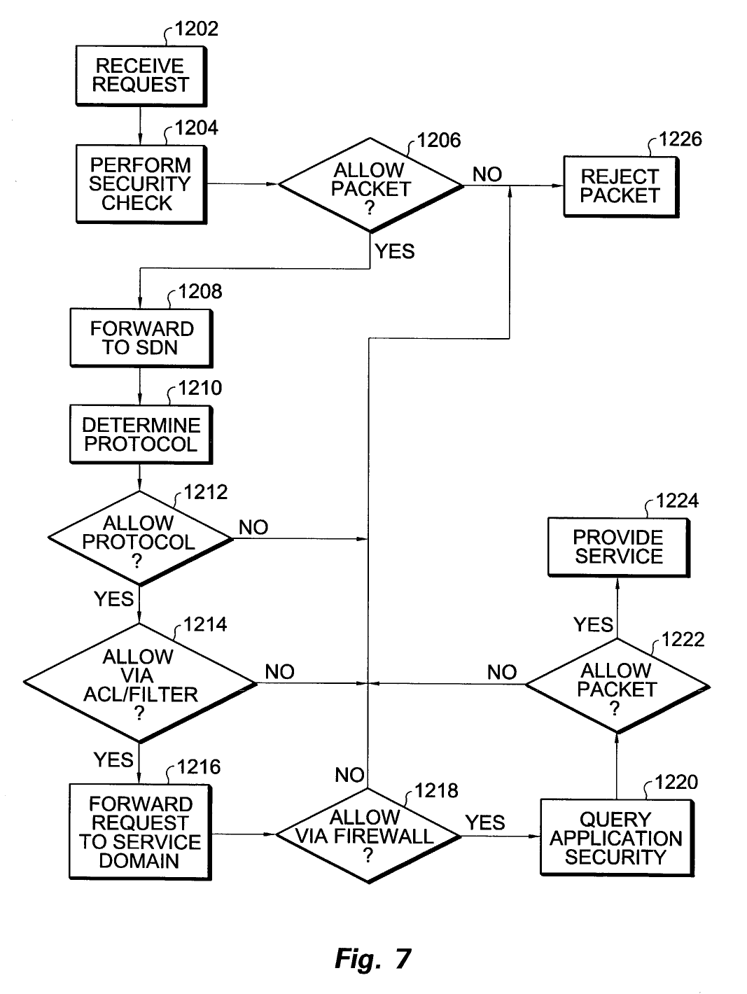

FIG. 7 depicts a flowchart for delivering a data packet in a network having a security configuration in accordance with an embodiment of the present invention. Although FIG. 7 discloses using a network as disclosed above, the feature, functions, and steps disclosed with regard to FIG. 7 may be applicable to any network that seeks to provide secure services to an end user. Further, additional known security measures may be combined with those disclosed to provide additional security to networks, and the disclosed features are not exclusive in providing security to a network.

Step 1202 executes by receiving a request, preferable at a service delivery interface. The request may be a data packet that requests a specific service that is delivered over the network to an end user. Step 1204 executes by performing a security check on the data packet by an integration security module. The integration security module may be configured between the service delivery interface and the service delivery network. If the integration security module is not present in the configuration, then this step may be skipped.

Step 1206 executes by determining whether the integration security module allows the data packet. If yes, then step 1208 executes by forwarding the data packet to the service delivery network. Alternatively, the data packet may be forwarded to any applicable network. If step 1206 is no, then step 1226 is executed, as disclosed below.

Step 1210 executes by determining the protocol for the data packet. Step 1212 executes by determining whether the protocol is allowed on the service delivery network. If no, then step 1226 is executed, as disclosed below. If yes, then step 1214 executes by determining whether the data packet is allowed by the filters and/or access control lists for the service delivery network. These filters and access control lists may be part of the process control and protocol validation layers for the network, as disclosed above. If yes, then step 1216 executes by forward the data packet enclosing the request to the appropriate service domain. The request may be forwarded based upon the virtual IP of the service domain. If step 1214 is no, then step 1226 executes, as disclosed below.

Step 1218 executes by determining whether the data packet enclosing the request should be allowed according to the host-based firewall. The host-based firewall preferably secures a network appliance, such as a server. If no, then step 1226 executes, as disclosed below. If step 1218 is yes, then step 1220 executes by querying the security for the application supported by the service domain. The application security may include additional safeguards or checks that are addressed prior to delivering the data packet. Step 1222 executes by determining whether to allow the packet according to application security. If yes, then step 1224 executes by providing the service requested by the delivered data packet. The service may be provided from the service domain that matched the destination virtual IP of the data packet.

If step 1222 is no, then step 1226 executes by rejecting the data packet enclosing the request. A rejected data packet may be handled in any appropriate manner. The rejection may be logged by the network sending the request and an error message may be given to the end user. An access denied message also may be sent to the end user. The rejected data packet may be logged for future consideration. Further, a recheck of the request may occur according to the steps disclosed above.

Thus, the disclosed embodiments provide advantages and improvements over known network systems. The nature of the internet economy is dynamic. Thus, network security infrastructure should change in terms of size and functionality. By incorporating a modularized architecture as disclosed above, new security configurations and functions may be integrated by conceptualizing the functions as modules and mapping from conceptual modules to physical modules that comprise hardware and software components at varying levels of abstraction. The disclosed embodiments allow the system architecture to be loosely coupled so that addition and removal of services and components may occur without major integration efforts. Further, the security structure may be changed as applications change.

It will be apparent to those skilled in the art that various modifications and variations can be made in the present invention without departing from the spirit or scope of the invention. Thus, it is intended that the present invention covers the modifications and variations of this invention that come within the scope of any claims and their equivalents.

What is claimed:

1. A network for delivering a plurality of services in a secured environment, comprising:
a service module supporting a service from said plurality of services; and
a load balancing switch to provide a virtual internet protocol address for said service, such that a data packet is routed to said service according to said virtual internet protocol address;
a distribution module coupled to said service module, wherein said distribution module routes said data packet to said load balancing switch; and
an integration security module coupled to said distribution module, wherein said integration security module passes said data packet to said distribution module when said data packet is authorized for said virtual internet protocol address.

2. The network of claim 1, wherein said integration security module comprises a security enhancing configuration.

3. The service delivery network of claim 1, wherein said service is coupled to said load balancing switch by at least one host connection switch.

4. The service delivery network of claim 1, wherein said service has a physical address.

5. The service delivery network of claim 4, wherein physical address corresponds to said virtual internet protocol address.

6. The network of claim 1, further comprising a service security module coupled to said service module, wherein said service security module passes said packet to said service module when said packet is authorized for said virtual internet protocol address.

7. The network of claim 1, wherein said service includes a network attached device to support an application.

8. The network of claim 7, wherein said network attached device is a server.

9. The network of claim 8, wherein said server includes a host-based firewall.

10. The network of claim 8, wherein software on said server is secured using minimization.

11. The network of claim 8, wherein software on said server is secured using hardening.

12. The network of claim 8, wherein said server implements a chroot environment.

13. A network configured to deliver a service over a network in a secured environment, comprising:
a service module hosting said service, wherein said service correlates to a virtual internet protocol address;
a load balancing switch to route information to said service according to said virtual internet protocol address; and
a service security module to determine whether a data packet for said service is authorized according to said virtual internet protocol address.

14. The network of claim 13, wherein said service security module includes a security enhancing configuration.

15. The network of claim 13, further comprising a distribution module coupled to said service security module, wherein said distribution module routes said data packet.

16. The network of claim 15, further comprising an integration security module to determine whether said data packet is allowed to said distribution module.

17. The network of claim 13, further comprising a filter associated with said service module to validate said data packet.

18. The network of claim 13, further comprising an access control list associated with said service module to validate said data packet.

19. The network of claim 13, wherein said service is hosted on a server having a host-based firewall to determine whether said data packet is allowable.

20. A method for delivering a request for a service over a network in a secure manner, comprising:
receiving said request for said service, wherein said request comprises a data packet bound for a virtual internet protocol address;
determining with a security module whether said data packet is authorized for said virtual internet protocol address; and
forwarding said request to said service correlating to said virtual internet protocol address when said data packet is authorized by said security module.

21. The method of claim 20, wherein said security module is an integration security module.

22. The method of claim 20, wherein said security module is a service security module.

23. The method of claim 20, further comprising determining a protocol for said data packet.

24. The method of claim 23, further comprising allowing said data packet to said service module according to said protocol.

25. The method of claim 24, wherein said allowing includes filtering said data packet.

26. The method of claim 24, wherein said allowing includes checking an access control list.

27. The method of claim 20, further comprising providing said service from a service domain.

28. The method of claim 20, further comprising rejecting said data packet when said request is not authorized for said virtual internet protocol address.

29. A system for delivering a request for a service over a network in a secure manner, comprising:
means for receiving said request for said service, wherein said request comprises a data packet bound for a virtual internet protocol address;
means for determining with a security module whether said data packet is authorized for said virtual internet protocol address; and
means for forwarding said request to said service correlating to said virtual internet protocol address when said data packet is authorized by said security module..

30. A method for providing a service over a secured network, comprising:
performing a security check on a request for said service, wherein said service correlates to a virtual internet protocol address within said secured network;
determining whether said request is allowed for said service according to said virtual internet protocol address; and
forwarding said request to a service domain correlating to said virtual internet protocol address according to said security check.

31. The method of claim 30, further comprising delivering said service to an end user corresponding to said request.

32. The method of claim 30, wherein said security check is an integration security module.

33. The method of claim 30, wherein said security check is a service security module.

34. The method of claim 30, wherein said security check is a security enhancing device.

35. The method of claim 30, wherein said security check is a filter.

36. The method of claim 30, wherein said security check is an access control list.

37. A system for providing a service over a secured network, comprising:
means for performing a security check on a request for said service, wherein said service correlates to a virtual internet protocol address within said secured network;
means for determining whether said request is allowed for said service according to said virtual internet protocol address; and
means for forwarding said request to said service correlating to said virtual internet protocol address according to said security check.

38. A method for authorizing a data packet having a request for a service over a network, comprising:
receiving said data packet at a security module; and
forwarding said data packet to a service supporting said service according to said security module.

39. The method of claim 38, further comprising allowing said data packet to said service according to a virtual internet protocol address of said service.

40. The method of claim 38, wherein said security module is a service security module.

41. The method of claim 40, further comprising accessing a service module having said service according to said service security module.

42. The method of claim 38, wherein said security module is an integration security module.

43. The method of claim 42, further comprising accessing a distribution module coupled to said service according to said integration security module such that said distribution module routes said data packet to said service.

44. A system for authorizing a data packet having a request for a service over a network, comprising:
means for receiving said data packet at a security module; and
means for forwarding said data packet to a service domain supporting said service according to security module.

45. A computer program product comprising a computer useable medium having computer readable code embodied therein for delivering a request for a service over a network in a secure manner, the computer program product adapted when run on a computer to execute steps, including:
receiving said request for said service, wherein said request comprises a data packet bound for a virtual internet protocol address;
determining with a security module whether said data packet is authorized for said virtual internet protocol address; and
forwarding said request to a service domain correlating to said virtual internet protocol address when said data packet is authorized by said security module.

46. A computer program product comprising a computer useable medium having computer readable code embodied therein for providing a service over a secured network, the computer program product adapted when run on a computer to execute steps, including:
performing a security check on a request for said service, wherein said service correlates to a virtual internet protocol address within said secured network;
determining whether said request is allowed for said service according to said virtual internet protocol address; and
forwarding said request to a service domain correlating to said virtual internet protocol address according to said security check.

47. A computer program product comprising a computer useable medium having computer readable code embodied therein for authorizing a data packet having a request for a service over a network, the computer program product adapted when run on a computer to execute steps, including:
receiving said data packet at a security module; and
forwarding said data packet to a service domain supporting said service according to said security module.
